(19) United States
(12) Patent Application Publication
(10) Pub. No.: US 2014/0069860 A1
(43) Pub. Date: Mar. 13, 2014

(54) MEMBRANE SEPARATION DEVICE

(71) Applicant: MEIDENSHA CORPORATION, Tokyo (JP)

(72) Inventors: Hiroshi NOGUCHI, Tokyo (JP); Tairi LI, Tokyo (JP)

(73) Assignee: MEIDENSHA CORPORATION, Tokyo (JP)

(21) Appl. No.: 13/974,567

(22) Filed: Aug. 23, 2013

Related U.S. Application Data
(63) Continuation of application No. PCT/JP2012/051371, filed on Jan. 23, 2012.

(30) Foreign Application Priority Data
Feb. 28, 2011 (JP) 2011-041486

(51) Int. Cl. B01D 65/08; C02F 3/20

(52) U.S. Cl. CPC B01D 65/08; C02F 3/208
USPC 210/321.69

(57) ABSTRACT

A membrane separation device comprises a membrane unit that includes membrane modules piled in a direction of a depth of a biological reactor, an air diffusing member arranged below the membrane unit to diffuse air for cleaning membranes of the membrane unit and an air bubble group splitting member arranged between the membrane unit and the air diffusing member to split an air bubble group supplied from the air diffusing member into air bubble groups. The air bubble group splitting member has a diameter larger than that of the air diffusing member and is a three-dimensional obstruction member arranged in parallel with an axis of the air diffusing member. The air bubble group splitting member has a vertical cross section of which a lower part is projected downward, and has a vertical cross section of which an upper part is triangular and a lower part is semicircular.

### TECHNICAL FIELD

The present invention relates to membrane separation devices and particularly to the membrane separation devices of a type that is used in water treatment.

### BACKGROUND ART

Hitherto, a membrane separation technology has been used in the field of desalination of seawater, purification of water, separation of gas, purification of blood and the like. In current days, in view of environmental protection, research for applying the membrane separation technology to a wastewater treatment is being advanced.

Hitherto, as a method for carrying out a solid-liquid separation of before-treatment water (viz., water to be treated) having a high turbidity, sand filtration method, gravitational sedimentation method or the like has been used particularly in the field of water purification treatment, sewage/drain water treatment and industrial waste water treatment. However, the solid-liquid separation employed in these methods tends to have such drawbacks that the purity of the treated water fails to have a satisfied level and a very large site is needed for the plant due to the nature of the solid-liquid separation.

For eliminating the above-mentioned drawbacks, there have been proposed various methods in which the solid-liquid separation is carried out by placing membrane modules, which are each constructed to install therein separation membranes such as microfiltration membranes, ultrafiltration membranes or the like, in water which is to be treated. It has been revealed that if before-treatment water is subjected to a filtration treatment by using such separation membranes, highly purified water is obtained (see Non-Patent Document 1).

In case of carrying out the solid-liquid separation of the before-treatment water by using such separation membranes, clogging of outer surfaces of the separation membranes is induced by particles in suspension and gradually worsened as the filtration treatment is continued, and thus, reduction in filtration flow and/or increase in transmembrane pressure difference is caused. In order to recover such undesired condition, there has been adopted a method in which an air diffusing device is arranged below the membrane modules to carry out a diffusion of air bubbles therefrom causing flows of air-water mixture produced by upward-moving of the air bubbles to contact membrane surfaces of the membrane modules (viz., scrubbing) thereby peeling the clogging particles off the surfaces of the separation membranes.

One important point of this membrane surface cleaning method by air is how to evenly supply the cleaning air bubbles onto an entire surface (in horizontal cross section) of the membrane. That is, because the cleaning of the membrane surface is carried out by contacting the air-water mixture flow produced by the diffusion of air bubbles to the membrane surface, it is important to contrive means by which air bubbles fed from an air diffusing tube are uniformly dispersed. In this respect, for example, Patent Documents 1 to 4 show some membrane separation devices that are improved in dispersing the air bubbles.

An air diffusing tube of the membrane separation device of Patent Document 1 is cylindrical in shape and formed at its lower cylindrical wall portion with a plurality of slit-like diffusing openings that are aligned to be perpendicular to an axis of the air diffusing tube.

In the membrane separation devices disclosed in Patent Documents 2 to 4, an air diffusing device (or air diffusing tube) is provided for each separation membrane in order that the air bubbles for scrubbing the particles are uniformly and sufficiently supplied to the entire surface of the separation membranes. Furthermore, in order to increase a dissolution efficiency of the scrubbing air relative to before-treatment water, a grid-like or net-like air dispersing member is arranged above the air diffusing device so as to produce air bubbles whose diameter is smaller than that of the air bubbles produced by the air diffusing device.

In the membrane separation device of Patent Document 1, a certain effect is achieved by keeping the amount to of air fed from each diffusing opening of the air diffusing tube at a constant level. A delicate height difference between the air diffusing openings is inevitably produced due to the manner in which the membrane separation device was set, the aged deterioration of the air diffusing tube caused by the air diffusing energy and the water pressure (which is not a hydrostatic water pressure but a dynamic water pressure) in the water flow, and thus, expected effect has a limit even though improvement is applied to the construction of the air diffusing tube.

Since the air diffusing openings of the air diffusing device are each shaped like a slit, shortage of air supply from the air diffusing device, which would occur when the air diffusing openings are closed, is suppressed. However, since the air diffusion is not equally or evenly effected in a horizontal direction, it tends to occur that the surface of the separation membrane has uneven cleaned portions.

If, due to the uneven cleaning of the membrane surface of each membrane module, there are produced highly smudged portions and lowly smudged portions on the membrane surface, the actual filtration is carried out by only the “easily cleanable part of the membrane surface” and thus, an effective filtration area which is actually usable is reduced. Furthermore, since this easily cleanable part of the membrane surface is always exposed to the filtration, a membrane filing, which means clogging by the particles in suspension, tends to speed up at the easily cleanable part of the membrane surface, and thus, it becomes necessary to reactivate the filtering performance of the membrane by effecting a cleaning with chemical solution or by effecting a physical cleaning before the estimated usable time when continuation of filtration by the membrane is not recommended. Accordingly, the interval for the work of reactivating the filtering performance of the membrane is shortened, and thus, due to reduction in amount of filtered water produced between intervals and stopping of operation of the membrane separation by the work, overall efficiency of the membrane separation is lowered.

The dispersing means provided by the membrane separation devices disclosed by Patent Documents 2 to 4 is a horizontally arranged member which is made of wire net, perforated plate, pipe, wire or grid. The opening ratio of the dispersing means is set to 20 to 70% and the scale spacing is set to 2 to 10 mm. In view of the shape of the air bubbles, the dispersing means employs an apertured member that is inserted into a given position for fragmentally splitting large-sized air bubbles and aims to improve the dissolution efficiency by the diffusion effect of the air bubbles and uniformly or evenly supply the air bubbles to the membrane portion by the diffusion effect of the air bubbles. The aim of providing the dispersing means is to eliminate a remarkable reduction in dissolution efficiency which would be caused by the large-sized air bubbles and eliminate the partially smudged portions of the membrane which would be caused by unbalanced air bubble induction into a space between membranes.

However, the air bubbles to be produced by the air diffusing device that serves as both an oxygen feeder and a membrane cleaner should be minute in size when the air diffusing device serves as the oxygen feeder and relatively large when the air diffusing device serves as the membrane cleaner. That is, in order to achieve both effects, it is necessary to make a selection from two air diffusion methods based on directly-opposed requirements. In the membrane separation device disclosed by Patent Document 4, a group of air bubbles supplied from an air diffusing member are fractionated by a wire-net like dispersing means or grid-like dispersing means, and thus, uneven cleaning tends to occur on the surface of the separation membrane, which deteriorates the membrane cleaning performance. Furthermore, it is necessary to arrange a plurality of air diffusing tubes or increase the number of the tubes in accordance with the area possessed by a lower surface of the dispersing means. Even though the number of the air diffusing points is increased due to setting of the air diffusing tubes and/or increase of the number of the tubes, the air diffusion is not equally or evenly made in a horizontal direction, and thus, it tends to occur that the surface of the separation membrane has uneven cleaned portions. This brings about not only reduction in separation efficiency of the entire construction of the membrane but also reduction in reliability of the membrane separation treatment.

### Prior Art Documents

### Non-Patent Document

Non-Patent Document 1: Taichi Uesaka and three other persons, [Submerged Membrane used for upgrading Drain Water Treatment and for Recycle], Kubota Technical Report, June, 2005, vol. 39, p 42 to 50.

### Patent Documents

Patent Document 1: Japanese Laid-open Patent Application (Tokkaihei) 10-286444
Patent Document 2: Japanese Laid-open Patent Application (Tokkaihei) 8-281080
Patent Document 3: Japanese Laid-open Patent Application (Tokkai) 2001-162141
Patent Document 4: Japanese Laid-open Patent Application (Tokkai) 2006-224050

### SUMMARY OF THE INVENTION

Accordingly, the present invention provides a membrane separation device which comprises a membrane unit that includes a plurality of membrane modules piled in the direction of the depth of a water tank, an air diffusing member that is arranged below the membrane unit to diffuse air for cleaning membranes of the membrane unit, and an air bubble group splitting member that is arranged between the membrane unit and the air diffusing member to split an air bubble group supplied from the air diffusing member into a plurality of air bubble groups.

The air bubble group splitting member may have a diameter larger than that of the air diffusing member and may be an obstruction member with a three dimensional shape that is arranged in parallel with an axis of the air diffusing member. If so, the air bubble group supplied from the air diffusing member collides against the air bubble group splitting member to be evenly split into a plurality of air bubble groups using the axis of the air diffusing member as a center line. Thus, the split air bubble groups can be evenly supplied to a lower end of the membrane unit without adding another air diffusing member and increasing the number of air diffusing points.

The air bubble group splitting member may have a vertical cross section of which lower part is projected downward. If so, a resistance against the air bubble group supplied from the air diffusing openings of the air diffusing member is reduced, so that the air bubble group can be evenly split into a plurality of air bubble groups without reducing a flow speed of air-water mixture.

If the air bubble group splitting member has a vertical cross section of which lower part is semicircular in shape, the air bubble group colliding against the member is split into a plurality of air bubble groups while keeping a turbulent flow condition on the curved surface of the member. Furthermore, if the air bubble group splitting member has a vertical cross section of which upper part is triangle in shape, the air bubble group splitting member can effectively guide the suspension to a lower position of the air bubble group splitting member.

If the air bubble group splitting member has a vertical cross section which is circular in shape or a vertical cross section of which upper part is shaped like a bell and of which lower part is semicircular in shape, the flow of the air-water mixture moving upward along the curved lower surface of the air bubble group splitting member is forced to turn at a position above the air bubble group splitting member and such flow turning is kept.

### BRIEF DESCRIPTION OF THE DRAWINGS

FIG. 1 is a sectional view schematically showing a construction of a membrane separation device of a first embodiment of the present invention.

FIG. 2(a) is a bottom view of an air diffusing member employed in the first embodiment, and FIG. 2(b) is a vertically sectioned view of the air diffusing member.

FIG. 3(a) is a vertically sectioned view of an air bubble group splitting member that has a vertical cross section of which lower part is semicircular in shape, FIG. 3(b) is a vertically sectioned view of an air bubble group splitting member that has a vertical cross section of which upper part is obtuse-triangular in shape and of which lower part is semicircular in shape, and FIG. 3(c) is a vertically sectioned view of an air bubble group splitting member that has a vertical cross section of which upper part is acute triangular in shape and of which lower part is semicircular in shape, FIG. 3(d) is a vertically sectioned view of an air bubble group splitting member that has a circular vertical cross section, and FIG. 3(e) is a vertically sectioned view of an air bubble group splitting member that has a vertical cross section of which upper part is shaped like a bell and of which lower part is semicircular in shape.

FIG. 4(a) is a bottom view of an air diffusing member employed in a second embodiment, FIG. 4(b) is a vertically sectioned view of the air diffusing member and FIG. 4(c) is a bottom view of the air bubble group splitting member employed in the first embodiment.

FIG. 5(a) is a bottom view of an air diffusing member employed in a third embodiment and FIG. 5(b) is a vertically sectioned view of the air diffusing member.

FIG. 6(a) is a bottom view of an air diffusing member employed in a fourth embodiment and FIG. 6(b) is a vertically sectioned view of the air diffusing member.

FIG. 7 is a perspective view showing a construction of a membrane module which is used for embodying the invention.

### EMBODIMENTS FOR CARRYING OUT THE INVENTION

In the following, embodiments of the present invention will be described with reference to the drawings.

### First Embodiment

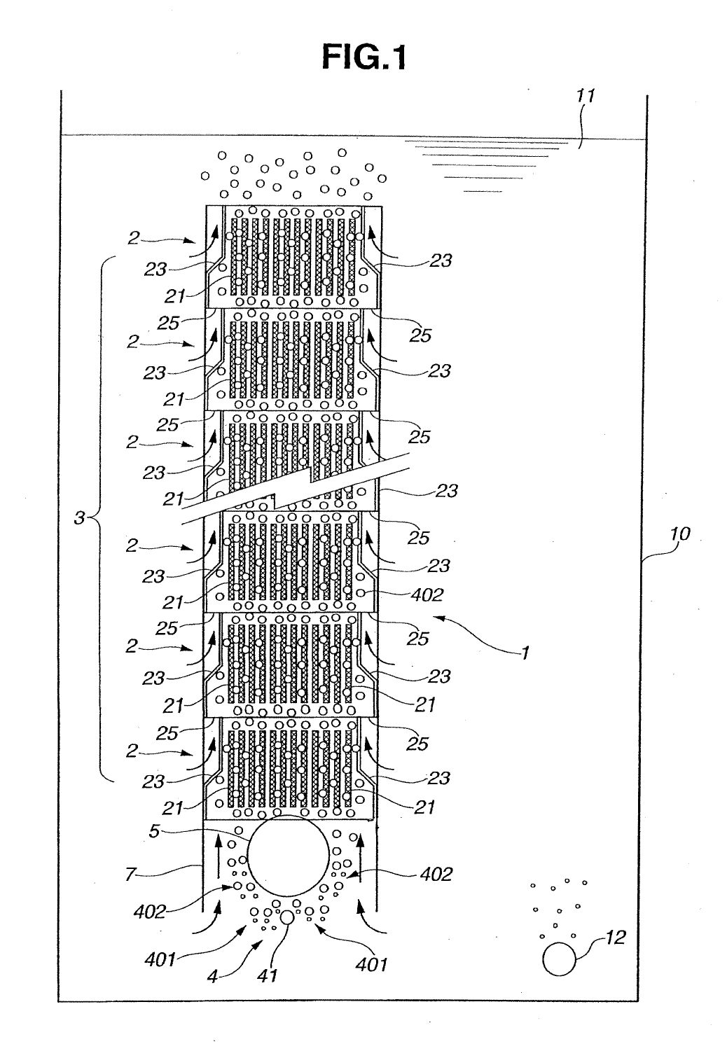

In a membrane separation device 1 of this embodiment shown in FIG. 1, groups of membrane cleaning air bubbles 401 fed by an air diffusing member 4 to a membrane module 3 in a MBR type biological reactor 10 are split into a plurality of air bubble groups 402 by an air bubble group splitting member 5, so that the cleaning effect of the membrane module is evenly made. That is, splitting the air bubble groups made in this embodiment is not for increasing the diffusion efficiency of oxygen by miniaturizing the air bubbles for increasing activity of activated sludge, but for directing the groups of air bubbles to a multi-direction by colliding the air bubbles from the air diffusing member against the air bubble group splitting member.

(Construction of the Membrane Separation Device 1)

The membrane separation device 1 comprises a membrane unit 3 that has a plurality of membrane modules 2 piled on one another in the direction of the depth of the biological reactor 10, an air diffusing member 4 that diffuses air bubbles to the membrane unit 3 for effecting both aeration and membrane cleaning, and an air bubble group splitting member 5 that splits groups of air bubbles into a plurality of air bubble groups. The membrane separation device 1 is arranged to be immersed in a liquid phase of the MBR type biological reactor 10.

As is shown in, for example, FIG. 7, each membrane module 2 comprises a plurality of flat type separation membranes 21 that are arranged in parallel with one another, a pair of supporting portions 22 that support both ends of each separation membrane 21 and a pair of guides 23 that close gaps provided near both ends of the pair of supporting portions 22.

Although the disclosed separation membranes 21 have each a flat shape, the separation membranes usable in the invention are not limited to such flat shape. That is, known separation membranes applicable to the MBR, which are, for example, organic hollow fiber membranes, organic flat membranes, inorganic flat membranes, inorganic single tube membranes or the like are usable. As a material of the separation membranes 21, cellulose, polyolefin, polysulfone, PVDF (polyvinyldeneflolyte), PTFE (polytetrafluoroethylene), ceramic or the like is usable. If desired, separation membranes 21 of the membrane module 2 may be so arranged that water collecting passages 211 provided in each separation membrane extend in a vertical direction. In this case, water collecting portions communicated with the water collecting passages 211 are provided in end portions of the of each separation membrane 21. The water collecting portion may be provided to both or one of upper and lower end portions of the separation membrane 21.

In each supporting portion 22, there are formed water collecting portions (not shown) that are communicated with water collecting passages 211 formed in each separation membrane 21. The water collecting portions are communicated with a filtering suction opening 24 provided by the supporting portion 22. To the filtering suction opening 24, there is connected a pipe of a pump (not shown) for sucking a before-treatment water.

Each of the guides 23 is connected to the supporting portions 22 in such a manner as to make a cross sectional area of an upper open end portion of the membrane module 2 smaller than that of a lower open end portion of the membrane module 2, so that improvement in filtering efficiency by each separation membrane 21 is achieved. That is, when a plurality of membrane modules 2 are piled on one another, a space 25 is defined between the upper open end portion of one module 2 and the lower open end portion of another module (not shown) that is piled on the one module 2 and, by permitting the before-treatment water around the membrane module 2 to flow into the space 25, increase of the concentration of activated sludge in the before-treatment water flowing through the membrane module 2 is suppressed. The air bubble groups 402 (see FIG. 1) diffused by the air diffusing member 4 are suppressed from travelling outside of the membrane module 3 by the guides 23, and thus, the air bubble groups 402 can effectively contact to the outer surface of each separation membrane 21.

Usually, the depth of the biological reactor 10 is about 4 m. The number of the membrane modules 2 to be piled is determined considering the weight and shape of the modules with respect to the depth and maintainability of the biological reactor 10. For example, the number of the membrane modules 2 is so determined as to cause the membrane unit 3 to have a height of 2 m to 3 m. The before-treatment water in the membrane unit 3 flows from an open portion provided at a lower part of the membrane unit 3 toward an open portion provided at an upper part of the membrane unit 3. Since the liquid phase in the membrane unit 3 is filtered by the separation membranes 21, the activated sludge concentration of the liquid phase increases as a vertical position in the membrane unit 3 increases. As is shown in FIG. 1, since the before-treatment water is sucked into the membrane separation unit 1 from the spaces 25 provided by the piled membrane modules 2, high increase of the activated sludge concentration in the membrane separation unit 1 can be suppressed. As a result, a load to the filtration is lowered, and thus, clogging of membranes is relieved and energy consumption is reduced. Since the suction force for sucking the before-treatment water into the membrane unit 3 is produced by the upward movement of the air-bubble groups 401 and 402, there is no need of providing a power source for sucking the before-treatment water.

The air diffusing member 4 is a member that feeds the membrane unit 3 with air for cleaning the membrane. An aeration air diffusing member 12 is a member that feeds the biological treatment by the activated sludge with needed oxygen. The air and oxygen are supplied by a blower (not shown) and a compressor (not shown) which are arranged outside of the biological reactor 10. As the air diffusing member 4, a member having a known specification may be used. Examples of the air diffusing member are of an air diffusing tube type, an air diffusing nozzle type and the like.

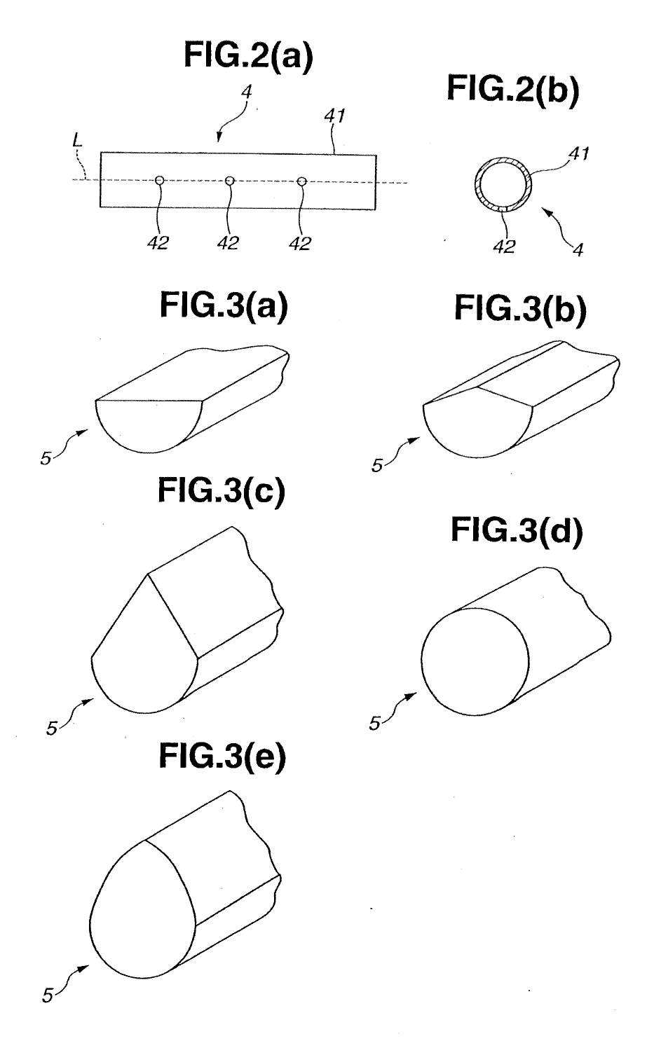

The air diffusing member 4 shown in FIG. 2(a) is an air diffusing tube 41 that is formed with a plurality of air diffusing openings 42. As is seen from FIG. 2(b), the air diffusing tube 41 is arranged horizontally at a position below the membrane unit 3. The plurality of air diffusing openings 42 are arranged so as to extend in parallel with an axis of the air diffusing tube 41 at a lower surface of the air diffusing tube 41. In order to cause the diffusing air from the air diffusing openings 42 to have a speed higher than 10 m/sec, the air diffusing openings 42 provided at the lower surface of the air diffusing tube 41 have each a diameter of 5 to 10 mm and are arranged with a pitch of 100 to 200 mm. With provision of the air diffusing openings 42 at the lower surface of the air diffusing tube 41, undesired entry of the tank liquid into the air diffusing tube 41, which would obstruct the air diffusion at the time when the pressure is lowered, is not easily induced even if the air diffusion is subjected to a pulsation due to fluctuation of pressure of air fed by a compressor or the like, and thus, the air diffusion can be kept stably.

In the following, the way for setting the number and diameter of the air diffusing openings will be described. Empirically, a total air diffusing volume Dm³/min is selected from a group of values 3Q, 6Q and 9Q that are determined by multiplying a design throughput Qm³/day of the biological reactor 10 by 3, 6 and 9.

Although a plurality of membrane separation devices 1 are set in the biological reactor 10 in accordance with a planned throughput, the above-mentioned way for setting the number and diameter of the air diffusing openings is carried out with respect to a single membrane unit 3.

Based on the diameter B mm and the number C of the air diffusing openings 42, a total area of the air diffusing openings 42 for each single membrane unit 3 is calculated. Then, the total air diffusing volume D is divided by the number of the membrane units 3 to obtain an air diffusing volume per each membrane unit 3, and then, the air diffusing volume is divided by the above-mentioned total area of the air diffusing openings to obtain an air diffusing speed E m/sec from the air diffusing openings 42. If the value of E thus obtained is equal to or higher than 10 m/sec, the diameter B and the number C of the air diffusing openings 42 are determined as suitable values.

Specific example of the diameter and number of the air diffusing openings 42 will be described. The diameter and number of the air diffusing openings will be explained in case wherein the design throughput Q is 0.6 m³/m²·day (19.8 m³/day) and the total air diffusing volume cm³/min is 6Q. When, with the total air diffusing volume being 6×Qm³/min, three air diffusing openings of which diameter is 5 mm are formed in an air diffusing tube of 200 mm in total length at a pitch of 56 mm, the above-mentioned calculation method provides that the speed E of the diffusing air from the air diffusing openings is about 12 m/sec. Since the calculated value of E is larger than 10 m/sec, the to diameter B mm of the air diffusing openings and the number C of the air diffusing openings of the specific example are considered as suitable values.

The air bubble group splitting member 5 is made of a material that does not permit passage of the air bubble groups is therethrough, not a material having network structure. The air bubble group splitting member 5 is made of an obstruction member with a three-dimensional shape that is larger than a diameter of the air diffusing member 4. The air bubble group splitting member 5 is placed between the membrane unit 3 and the air diffusing member 4 and so oriented that an axis of the air bubble group splitting member 5 extends in parallel with the axis of the air diffusing member 4. The air bubble group splitting member 5 is so arranged that the air bubbles 401 supplied from the air diffusing openings 42 of the air diffusing member 4 are evenly split into right and left groups with respect to the axis of the air bubble group splitting member 5 by colliding against the air bubble group splitting member 5. With this arrangement, the split air bubble groups can be evenly applicable to the lower end portion of the membrane unit 3. Although examples of a material of the air bubble group splitting member 5 are plastics, metals, ceramics, etc., the material is not limited to such examples so long as it is not deformed even when exposed to a rapid water stream caused by the air diffusion or it keeps a satisfied function as an obstruction member even when somewhat deformed.

The air bubble group splitting member 5 is a three-dimensional body having a vertical cross section of which lower part is projected downward. Due to such shape of the air bubble group splitting member, the resistance against the air bubble group 401 supplied from the air diffusing openings 42 of the air diffusing member 4 is reduced, so that the air bubble group 401 can be evenly split into the air bubble groups 402 without to reducing the flow speed of the air-water mixture.

Examples of the air bubble group splitting member 5 are shown in FIGS. 3(a) to 3(e). The air bubble group splitting member 5 exemplified by FIG. 3(a) has a vertical cross section of which lower part is semicircular in shape. The air bubble group is splitting member 5 exemplified by FIG. 3(b) has a vertical cross section of which upper part is obtuse-triangular in shape and of which lower part is semicircular in shape. The air bubble group splitting member 5 exemplified by FIG. 3(c) has a vertical cross section of which upper part is acute-triangular in shape and of which lower part is semicircular in shape. The air bubble group splitting member 5 exemplified by FIG. 3(d) has a vertical cross section that is circular in shape. The air bubble group splitting member 5 exemplified by FIG. 3(e) has a vertical cross section of which upper part is shaped like a bell and of which lower part is semicircular in shape.

The air bubble group splitting members 5 exemplified by FIGS. 3(a) to 3(e) are of a type of which lower part has a curved surface, so that each member 5 can split the air bubble group colliding against the lower curved surface into a plurality of air bubble groups while keeping the air bubble group in a turbulent flow condition on the lower curved surface. Particularly, since the air bubble group splitting members 5 exemplified by FIGS. 3(b) to 3(e) are of a type of which upper surface is projected upward, each member 5 can effectively guide the activated sludge toward a lower position of the member 5 and thus undesired deposition of the activated sludge on the member 5 can be avoided. Furthermore, since the air bubble group splitting members 5 exemplified by FIGS. 3(d) and 3(e) are of a type of which upper part constitutes a curved surface, each member 5 can produce and keep, at a position above the member 5, a turning movement (or swirl) of the flow of air-water mixture that has come up to the upper position along the curved lower surface of the member 5. With such turning movement, a violent flow of the air-water mixture can be kept at the position above the air bubble group splitting member 5 and thus splitting of the air bubble groups can be promoted. The violent flow of the air-water mixture that has been split and made a detour can be is led into the spaces between the separation membranes 21 of each membrane module 2, and thus, satisfied membrane surface cleaning effect can be maintained.

As is seen from FIG. 1, the air diffusing member 4 and the air bubble group splitting member 5 are installed in a housing 7 arranged below the membrane unit 3. It is to be noted that the relation between respective axes of the air diffusing member 4 and the air bubble group splitting member 5 and the direction in which a membrane surface of each separation membrane 21 installed in the membrane module 2 extends is not limited to the relation exemplified by FIG. 1. For example, an angle defined between the axes of the air diffusing member 4 and the air bubble group splitting member 5 and the direction of the membrane surface of each separation membrane installed in the membrane module 2 may be 90 degrees, not 0 degrees.

(Operation of the Embodiment)

Operation of the membrane separation device 1 will be described with reference to FIG. 1. The description will be directed to the operation of the membrane separation device 1 that is equipped with the air bubble group splitting device 5 of which vertical cross section is circular in shape.

Due to work of the aeration air diffusing member 12, the liquid phase in the biological reactor 10 into which the before-treatment water is supplied is constantly aerated. The activated sludge in the liquid phase biologically decomposes pollutants in the before-treatment water with the aid of oxygen supplied by the aeration. In addition to the above, due to work of the water flow produced by the above-mentioned air diffusion, the liquid phase in the biological reactor 10 is led into the membrane separation device 1 from the lower open end portion of the housing 7 and the spaces 25 defined between the membrane modules 2 and then subjected to a solid-liquid separation treatment.

In the membrane separation device 1, there are constantly released groups 401 of air bubbles from the air diffusing member 4. Upon colliding against the air bubble group splitting member 5, the air bubble groups 401 are split into a plurality of air bubble groups 402. Since the air bubble group splitting member 5 has a circular shape in a vertical cross section, the air bubble groups 401 having collided against the lower surface of the member 5 are split into a plurality of air bubble groups 402 while keeping a turbulent flow condition on an outer surface of the member 5. Furthermore, since the upper half of the vertical cross section of the air bubble group splitting member 5 is semicircular in shape, the activated sludge stagnating around the lower end portion of the membrane unit 3 is guided to move downward along the outer surface of the member 5, and thus, undesired deposition of the activated sludge on the member 5 can be avoided. Thus, reduction in an absolute amount of the activated sludge that contributes to the deposition of pollutants can be suppressed. Furthermore, the flow of the air-water mixture that moves upward along the curved lower surface of the air bubble group splitting member 5 is forced to make and keep a turning movement at a position above the member 5 and thus, a violent flow of the air-water mixture is kept at the position above the air bubble group splitting member 5 and thus splitting of the air bubble groups can be promoted.

The violent flow of the air-water mixture that has been split and made a detour is led into the spaces between the separation membranes 21 of each membrane module 2 for cleaning the outer surfaces of the separation membranes 21. The impurities removed from the surfaces of the separation membranes 21 due to the cleaning are carried by the flow of the air-water mixture and discharged to the outside from an upper end open portion of the top membrane module 2 of the membrane unit 3 or forced to settle down to the bottom or near is bottom of the biological reactor 10. The activated sludge contained in the removed impurities are reused for effecting the biological decomposition of the pollutants in the biological reactor 10.

Since, in the membrane unit 3, the interior of each separation membrane 21 of each membrane module 2 is kept negative in pressure due to work of a suction pump (not shown), a solid-liquid separation treated water having passed into the water collecting passages of the separation membranes 21 is discharged to the outside of the biological reactor 10 by the work of the suction pump.

In the membrane unit 3, there are produced upward flows of the liquid phase due to the work of the aeration air diffusing member 12 and the air diffusing member 4, and thus, the liquid phase led into the membrane modules 2 is subjected to a solid-liquid separation treatment by the separation membranes 21. Thus, the activated sludge concentration of the liquid phase flowing in the membrane unit 3 increases as a vertical position in the membrane separation device 1 increases. Accordingly, the sludge loading to the separation membranes 21 of the upper membrane modules 2 is increased and thus, there is such a possibility that clogging of the membranes is quickened and energy consumption is increased. In the membrane unit 3, with the work of the upward flows, the liquid phase staying around each membrane module 2 is led into the membrane module 2 from the space 25 defined between the lower end of the water flow guide 23 of the membrane module 2 and the upper end of the water flow guide 23 of another membrane module 2 that is positioned below the membrane module 2. With this flow of the liquid phase, increase of the activated sludge concentration in the membrane unit 3 is restrained, and thus, harmful effects caused by the increase of the sludge loading is avoided.

Furthermore, since, due to provision of the water flow guide 23, the flow passage for the air-water mixture containing the air bubble groups 402 become thin as the position nears the upper end of each membrane module 1, the flow of the air-water mixture is converged and at the same time the speed of the flow becomes high resulting in that the cleaning effect to the separation membranes 21 by the air bubble groups 402 is increased.

### Effects of the Embodiment

According to the membrane separation device 1, the membrane cleaning air bubble groups 401 supplied from the air diffusing member 4 to the membrane unit 3 in the biological reactor 10 are split into a plurality of air bubble groups 402 by the air bubble group splitting member 5. The split air bubble groups 402 are then evenly applied to each of the membrane modules 2 of the membrane unit 3, and thus, uneven cleaning of the membrane surfaces of the membrane unit 3 is not likely to occur. Thus, an effective membrane surface ratio is kept high, and thus, a high effective solid-liquid separation is possible. Furthermore, since high fragmentation of the air bubble groups 401 is avoided, the split air bubble groups can have a mean bubble diameter larger than that of the highly fragmented air bubbles and thus, the split air bubble groups can have a high buoyancy resulting in that the flow speed of the air-water mixture can be kept high. As is described hereinabove, according to the embodiment, the solid-liquid separation function of the separation membranes of the membrane module 3 for suppressing uneven cleaning of the membrane surface can be kept without adding another air diffusing member and increasing the number of air diffusing points. Although the disclosed air diffusing member 4 is of a tube type, a member of a nozzle type having air diffusing openings directed upward is usable. Of course, in this case, the air bubble groups supplied by the air diffusing member 4 can be split by the air bubble group splitting member 5.

### Second Embodiment

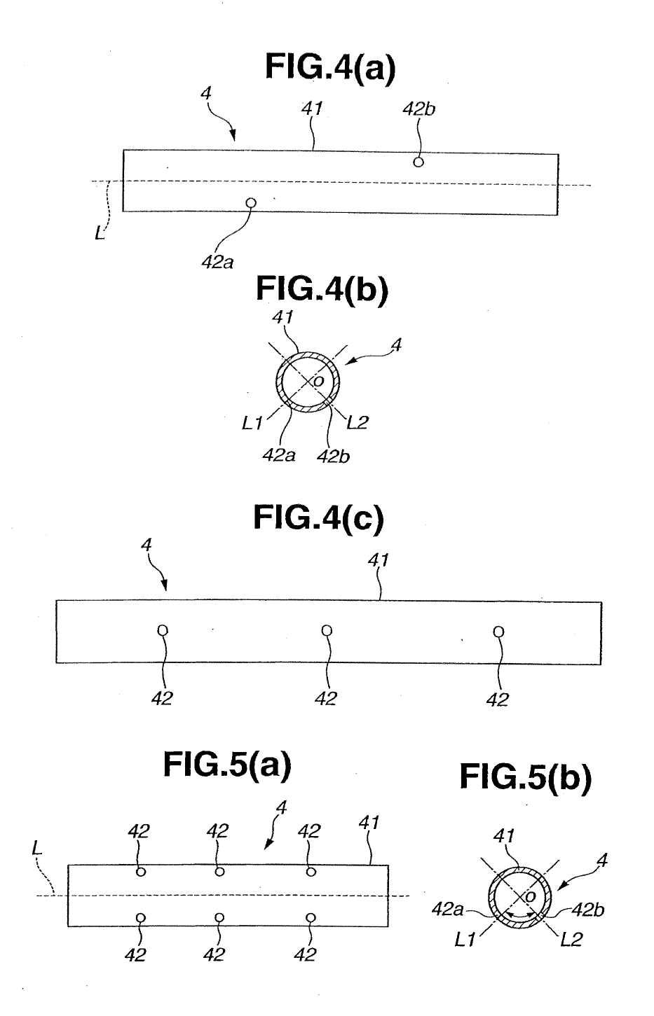

As is seen from FIG. 4(a), an air diffusing member 4 employed in the second embodiment has at its lower side two air diffusing openings that are spaced from each other in a right-left direction. In this arrangement, due to a synergistic effect between it and the air bubble group splitting member 5, much evenly splitting of the air bubble groups is expected.

That is, in the air diffusing member 4 employed in this embodiment, the adjacent air diffusing openings 42 are arranged at mutually oblique positions with respect to an axis L of the air diffusing tube 41. The adjacent air diffusing openings 42a and 42b are so arranged that a straight line L1 passing through the air diffusing opening 42a and a tube center O of the air diffusing tube 41 and another straight line L2 passing through the other air diffusing opening 42b and the tube center O define therebetween an angle that is smaller than 180 degrees, preferably equal to or smaller than 170 degrees. In a specific shape of the air diffusing tube shown in FIG. 4(b), the adjacent two air diffusing openings 42a and 42b are so arranged that the straight line L1 passing through the air diffusing opening 42a and the tube center O of the air diffusing tube 41 and the other straight line L2 passing through the other air diffusing opening 42b and the tube center define therebetween an angle of 90 degrees.

In the following, a specific example for setting the diameter and the number of the air diffusing openings 42 of the air diffusing member 4 employed in this second embodiment will be described. Explanation for setting the diameter and the number of the air diffusing openings will be directed to a case wherein the design throughput Q is 0.6 m³/m²·day (19.8 m³/day) and the total air diffusing volume Dm³/min is 6Q. When, with the total air diffusing volume being 6×Qm³/min, two air diffusing openings of which diameter is 6 mm are formed in an air is diffusing tube of 225 mm in total length at a pitch of 75 mm, the calculation method mentioned in the first embodiment provides that the speed E of the diffusing air from the air diffusing openings is about 12 m/sec. Since the calculated value of E is larger than 10 m/sec, the diameter B mm of the air diffusing openings and the number C of the air diffusing openings of the specific example are understood as suitable values.

In the above-mentioned air diffusing member 4 employed in this second embodiment, the air bubble groups can be evenly supplied in right and left directions by the member 4 using the axis of the member 4 as a center line, and thus, as compared with the air diffusing member 4 of the first embodiment in which, as is seen from FIG. 4(c), the air diffusing openings are aligned, the air bubble groups can be much more evenly supplied to the membrane unit 3.

### Third Embodiment

As is seen from FIG. 5(a), an air diffusing member 4 employed in the third embodiment has a plurality of air diffusing openings 42 that are arranged to form two rows with respect to an axis L of the air diffusing tube 41. The illustrated air diffusing openings 42a and 42b are so arranged that a straight line L1 passing through one of the air diffusing openings 42a placed in one row and a tube center O of the air diffusing tube 41 and another straight line L2 passing through an opposed one of the air diffusing openings 42b placed in the other row and the tube center O define therebetween an angle that is smaller than 180 degrees, preferably equal to or smaller than 170 degrees. In a specific shape of the air diffusing tube shown in FIG. 5(b), the to mutually opposed two air diffusing openings 42a and 42b are so arranged that the straight line L1 passing through the air diffusing opening 42a and the tube center O of the air diffusing tube 41 and the other straight line L2 passing through the opposed air diffusing opening 42b and the tube center O define is therebetween an angle of 90 degrees.

In the following, a specific example for setting the diameter and the number of the air diffusing openings 42 of the air diffusing member 4 employed in this third embodiment will be described. Explanation for setting the diameter and the number of the air diffusing openings will be directed to a case wherein the design throughput Q is 0.6 m³/m²·day (19.8 m³/day) and the total air diffusing volume Dm³/min is 12Q. When, with the total air diffusing volume being 12×Qm³/min, six air diffusing openings of which diameter is 5 mm are formed in an air diffusing tube of 225 mm in total length at a pitch of 56 mm, the calculation method mentioned in the first embodiment provides that the speed E of the diffusing air from the air diffusing openings is about 12 m/sec. Since the calculated value of E is larger than 10 m/sec, the diameter B mm of the air diffusing openings and the number C of the air diffusing openings of the specific example are understood as suitable values.

In the above-mentioned air diffusing member 4 employed in this third embodiment, the air bubble groups can be evenly supplied in right and left directions by the member 4 using the axis of the member 4 as a center line, and thus, as compared with the air diffusing member 4 of the first embodiment, the air bubble groups can be much more evenly supplied to the membrane unit 3. Furthermore, since the plurality of air diffusing openings 42 are arranged to form two rows with respect to the axis of the air diffusing tube 41, much concentrated air bubble groups can be evenly supplied to the membrane unit as compared with the air diffusing member 4 of the second embodiment.

### Fourth Embodiment

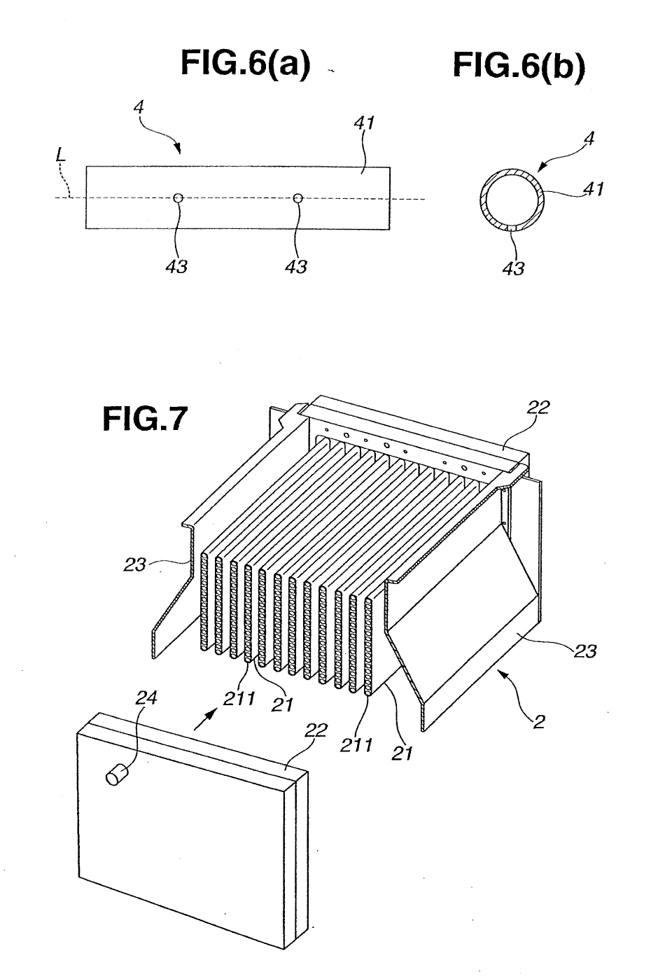

As is seen from FIG. 6, an air diffusing member 4 employed in the fourth embodiment has air diffusing openings 43 of which diameter is larger than that of the air diffusing openings 42 of the air diffusing member 4 employed in the first embodiment and of which number is smaller than that of the air diffusing openings 42. As is seen from FIGS. 6(a) and 6(b), the air diffusing openings 43 are provided at a lower surface of the air diffusing member 4.

In the following, a specific example for setting the diameter and the number of the air diffusing openings 43 of the air diffusing member 4 employed in this fourth embodiment will be described. Explanation for setting the diameter and the number of the air diffusing openings will be directed to a case wherein the design throughput Q is 0.6 m³/m²·day (19.8 m³/day) and the total air diffusing volume Dm³/min is 6Q. When, with the total air diffusing volume being 6×Qm³/min, two air diffusing openings of which diameter is 6 mm are formed in an air diffusing tube of 198 mm in total length at a pitch of 66 mm, the calculation method mentioned in the first embodiment provides that the speed E of the diffusing air from the air diffusing openings is about 12 m/sec. Since the calculated value of E is larger than 10 m/sec, the diameter B mm of the air diffusing openings and the number C of the air diffusing openings of the specific example are understood as suitable values.

In case of the air diffusing member 4 employed in this fourth embodiment, the total air diffusing volume that is 6×Qm³/min is equal to that in case of the air diffusing member 4 employed in the first embodiment (viz., the speed E of the diffusing air is about 12 m/sec). However, since the number of the air diffusing openings of the air diffusing member 4 employed in the fourth embodiment is less than that of the air diffusing member 4 employed in the first embodiment, a diffusing air amount (m³/min) per each air diffusing opening is larger than that of the air diffusing member 4 of the first embodiment. With this, in case of the fourth embodiment, there are produced flows of air-water mixture that are larger than those by the air diffusing member 4 of the first embodiment. The air bubble groups 401 supplied from the air diffusing member 4 move upward together with the flows of air-water mixture and collide against the air bubble splitting member 5 to be split into a plurality of air bubble groups 402. Since the flows of air-water mixture do not lose energy so much even when colliding against the member 5, the cleaning effect of the membrane unit 3 can be maintained. As is described hereinabove, according to the air diffusing member 4 employed in the fourth embodiment, the cleaning effect of the membrane unit is increased and maintained.

### Other Embodiments of the Invention

Application of the membrane separation device of the invention is not limited to a biological reactor in which, as in case of the first, second, third and fourth embodiments, an activated sludge is stagnated. That is, the device of the invention is applicable to water purification facilities that use coagulant and ordinary water treatment facilities, such as industrial waste treatment facilities and the like, that need the solid-liquid separation of pollutants.

### DESCRIPTION OF REFERENCE NUMERALS

1 . . . membrane separation device
2 . . . membrane module
3 . . . membrane unit
4 . . . air diffusing member, 42, 42a, 42b, 43 . . . air diffusing opening
5 . . . air bubble group splitting member
401, 402 . . . air bubble group

1. A membrane separation device which is characterized by having:
a membrane unit that includes a plurality of membrane modules piled on one another in the direction of the depth of a water tank;
an air diffusing member that is arranged below the membrane unit to diffuse air for cleaning membranes of the membrane unit; and
an air bubble group splitting member that is arranged between the membrane unit and the air diffusing member to split an air bubble group supplied from the air diffusing member into a plurality of air bubble groups.

2. A membrane separation device as claimed in claim 1, which is characterized in that the air bubble group splitting member has a diameter larger than that of the air diffusing member and the air bubble group splitting member is an obstruction member with a three dimensional shape that is arranged in parallel with an axis of the air diffusing member.

3. A membrane separation device as claimed in claim 2, which is characterized in that the air bubble group splitting member has a vertical cross section of which lower part is projected downward.

4. A membrane separation device as claimed in claim 3, which is characterized in that the air bubble group splitting member has a vertical cross section of which lower part is semicircular in shape.

5. A membrane separation device as claimed in claim 3, which is characterized in that the air bubble group splitting member has a vertical cross section of which upper part is triangular in shape and of which lower part is semicircular in shape.

6. A membrane separation device as claimed in claim 3, which is characterized in that the air bubble group splitting member has a vertical cross section that is circular in shape or has a vertical cross section of which upper part is shaped like a bell and of which lower part is semicircular in shape.

7. A membrane separation device as claimed in claim 1, which is characterized in that the air diffusing member is an air diffusing tube made of a tubular member and a plurality of air diffusing openings are formed in a lower surface of the air diffusing tube.

8. A membrane separation device as claimed in claim 7, which is characterized in that the air diffusing openings are so arranged that adjacent air diffusing openings are arranged at mutually oblique positions with respect to an axis of the air diffusing member.

9. A membrane separation device as claimed in claim 8, which is characterized in that the adjacent air diffusing openings are so arranged that a straight line passing through one of the air diffusing openings and a tube center of the air diffusing tube and another straight line passing through the other of the air diffusing openings and the tube center define therebetween an angle that is smaller than 180 degrees.

10. A membrane separation device as claimed in claim 7, which is characterized in that the plurality of air diffusing openings are arranged to form two rows with respect to an axis of the air diffusing tube.

11. A membrane separation device as claimed in claim 10, which is characterized in that the air diffusing openings are so arranged that a straight line passing through one of the air diffusing openings placed in one row and a tube center of the air diffusing tube and another straight line passing through an opposed one of the air diffusing openings placed in the other row and the tube center define therebetween an angle that is smaller than 180 degrees.
